(19) United States
(12) Patent Application Publication
(10) Pub. No.: US 2005/0049927 A1
(43) Pub. Date: Mar. 3, 2005

(54) Apparatus and process for blocking product returns

(76) Inventors: Cynthia Zelanis, Santa Clara, CA (US); Kevin Lou, San Jose, CA (US); Niraj Kanthi, Sunnyvale, CA (US); Jianpeng Shi, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/642,876

(22) Filed: Aug. 18, 2003

(51) Int. Cl. G06F 17/60

(52) U.S. Cl. 705/26

(57) ABSTRACT

In an embodiment, a method of blocking a return of products from a customer, includes: submitting, by the customer, an order to purchase a product from a vendor; shipping the purchased product to the customer; determining if a return of the purchased product should be approved or not be approved; and if the return of the purchased product is not approved, then blocking the return of the purchased product in order to prevent the return of the purchased product. In another embodiment, an apparatus for blocking a return of products from a customer, includes: a product return blocking system configured to receive an order to purchase a product by a customer, determine if a return of the purchased product should be approved or not be approved, and block the return of the purchased product in order to prevent the return of the purchased product if the return of the purchased product is not approved.

### TECHNICAL FIELD

Embodiments of the present invention relate generally to blocking of customer orders. More particularly, embodiments of the present invention relate to an apparatus and process for blocking product returns.

### BACKGROUND

An incoming order (e.g., an order for a particular product or service) may be placed by a customer via an online shopping website of a vendor or via a call-center of a vendor. One example of an online shopping website is the HPShopping website from HEWLETT-PACKARD COMPANY, Palo Alto, Calif., at <www.hpshopping.com>. Currently, when an incoming order is made by a customer, the incoming order will be reviewed for potential fraud by having a fraud analyst examine, for example, the dollar amount of the incoming order. Additionally, some online shopping websites, such as the above-noted HPShopping website, use the Address Verification Service (AVS) which is provided by, for example, VISA, MASTERCARD, and AMERICAN EXPRESS to verify the billing information provided by customers of the website. The AVS service matches the billing information provided by the customer with the billing information that is on file with the AVS.

However, in current online shopping websites and current call centers, there is no available method to prevent any of the following types of undesirable product returns by a customer: (1) unauthorized product returns; (2) past 30-days product returns (where 30 days is an example normal return policy for an ordered product); and (3) fraudulent product returns. If a customer was rejected by an initial agent (for the online shopping website or call center) to grant a product return, then the customer can hang up (or exit the online shopping website) and call back (or re-enter the online shopping website) until a different agent would grant the product return.

In one current approach, the product return is typically blocked by an agent (or a designated fraud team member) by use of the eFalcon® product which is an e-commerce fraud detection product from FAIR, ISSAC AND COMPANY, San Rafael, Calif., or by use of a fraud shield tool available from, for example, CLEARCOMMERCE CORPORATION, Austin, Tex. A fraud shield tool stores negative files (e.g., a particular address and/or phone number associated with a past known fraudulent order). These currently-used methods for blocking product returns are more complex and more time consuming for an agent or designated fraud team member responsible for blocking the product returns.

Therefore, the current technology in blocking the product returns is limited in its capabilities and suffers from at least the above deficiencies and constraints.

### SUMMARY OF EMBODIMENTS OF THE INVENTION

In an embodiment of the invention, a method of blocking a return of products from a customer, includes:

submitting, by the customer, an order to purchase a product from a vendor;

shipping the purchased product to the customer;

determining if a return of the purchased product should be approved or not be approved; and

if the return of the purchased product is not approved, then blocking the return of the purchased product in order to prevent the return of the purchased product.

The method may also further include: if the return of the purchased product is approved, then accepting and processing the return of the purchased product.

The method may also further include: if the return of the purchased product has been blocked, then unblocking the return of the purchased product in some instances to permit the return of the purchased product.

In another embodiment of the invention, an apparatus for blocking a return of products from a customer, includes: a product return blocking system configured to receive an order to purchase a product by a customer, determine if a return of the purchased product should be approved or not be approved, and block the return of the purchased product in order to prevent the return of the purchased product if the return of the purchased product is not approved.

The product return blocking system may be further configured to accept and process the return of the purchased product, if the return of the purchased product is approved.

The product return blocking system may be further configured to unblock the return of the purchased product in some instances to permit the return of the purchased product, if the return of the purchased product has been blocked.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) in accordance with an embodiment of the invention.

FIG. 2 is a block diagram illustrating additional details of a system for blocking a product return, in accordance with an embodiment of the invention.

FIG. 3 is block diagram of a webpage used in accordance with an embodiment of the invention.

FIG. 4 is block diagram of another webpage used in accordance with an embodiment of the invention.

FIG. 5 is block diagram of a webpage used in accordance with another embodiment of the invention.

FIG. 6 is block diagram of a table used in accordance with an embodiment of the invention.

FIG. 7 is a flowchart of a method for blocking returns, in accordance with an embodiment of the invention.

FIG. 8 is a flowchart of a method for solving the problem of a customer with a frequent return behavior, in accordance with an embodiment of the invention.

FIG. 9 is a flowchart of a method for solving the problem of lost orders, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

Embodiments of the invention advantageously prevent at least one of the following types of undesirable product returns by a customer: (1) unauthorized product returns; (2) past 30-days product returns (or product returns that occur after expiration of a period in which product returns are permitted for customers); (3) fraudulent product returns; and/or (4) other undesirable returns as defined by a vendor. Embodiments of the invention also advantageously permits a supervisor (of the product vendor) to unblock product returns, in order for a customer to return a shipped product to the vendor.

Embodiments of the invention can be used by call center agents who use a call center application for handling customer orders, or can be used by designated supervisors in an online shopping website.

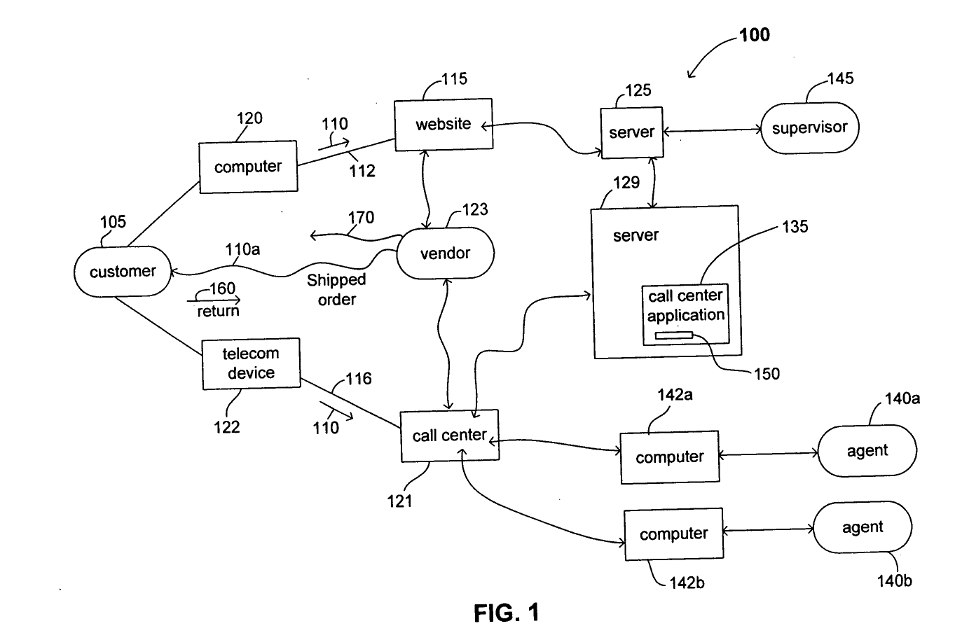

FIG. 1 is a block diagram of a system (or apparatus) 100 in accordance with an embodiment of the invention. A customer 105 may send an order 110 via a network 112 to an online shopping website 115 or may send the order 110 by calling a call-center 121 via telecommunication network 116. It is understood that the network 112 and network 116 may be the same network or may be network systems that can interface with each other. The order 110 may be, for example, an order for a particular product(s) that is provided by a vendor 123 associated with the online shopping website 115 and/or call center 121. The product is then shipped to the customer as a shipped order 110a, if the customer's purchase is approved by the vendor. Of course, the order 110 may also be for a service(s) provided by the vendor 123, in some instances.

The online shopping website 115 may be, for example, an online shopping website provided by HEWLETT-PACKARD COMPANY, Palo Alto, Calif., at <www.HPShopping.com>, other online shopping websites from other vendors or companies, an internal company shopping website, or another type of online shopping website. The network 112 may be any suitable communication network such as, for example, a wide area network (e.g., the Internet) or a local area network (LAN) or a telephone communication network. Similarly, the network 116 may be any suitable communication network that functions with the call center 121.

Typically, to send an order 110 to the online shopping website 115, the customer 105 will use a computer 120 to access and place the order 110 on the website 115. Typically, a server 125 (or other suitable computing device) is used to implement the online shopping website 115 and to receive and process the order 110 from the customer 105.

The server 125 includes a processor (not shown in FIG. 1) for executing various applications or programs in the server 125. Similarly, the computer 120 will also include a processor (not shown in FIG. 1) for executing various applications or programs in the computer 120. Various known components that are used in the server 125 and in the computer 120 are not shown in FIG. 1 for purposes of focusing on the functionalities of embodiments of the invention.

Typically, to send an order 110 to the call center 121, the customer 105 will use a telecommunication (telecom) device 122 (e.g., telephone or cellular phone) to place the order 110 to the call center 121.

In an embodiment, the system 100 includes a call center server 129 that can be accessed by one or more call center agents (generally shown as agents 140 and specifically shown in the example of FIG. 1 as agents 140a and 140b). Each agent 140 will use a computer (generally shown as computer 142) to access the server 129. In the example of FIG. 1, the agents 140a and 140b will use computers 142a and 142b, respectively, to access the server 129. Additional agents 140 may be associated with the call center 121 and may be able to also access the server 129.

In an embodiment, the server 129 includes a call center application 135 for processing the customer orders 110 by call center agents 140. One example of a suitable call center application 135 is TOMI (telephone order management interface) which permits customer orders to be processed in a call center by the call center agents 140, although other call center applications may be used. Various known components that are used in the server 129 and in the computers 142 are not shown in FIG. 1 for purposes of focusing on the functionalities of embodiments of the invention.

In an embodiment, the call center application 135 includes (or functions with) a product return blocking system 150 that permits a call center agent 140 (or an online shopping website supervisor 145) to prevent a product return 160 by a customer 105. The product return 160 is prevented from the customer 105 if the agent 140 (or supervisor 145) blocks a shipped order 110a, as described below.

A “shipped order” 110a is defined as a customer order 110, where the ordered product(s) have been previously shipped to the customer 105 from the vendor 123, or shipped to the customer 105 from an agent of the vendor 123, in some instances.

A “product return” 160 is defined as an actual product that is being returned by the customer 105. The product return 160 may also be a request by the customer 105 to return a product that has been previously shipped (or provided) by the vendor 123 to customer 105 in a shipped order 110a. In some instances, the product return 160 may also be a request by the customer 105 to cancel a service 170 that has been previously ordered by the customer 105 from the vendor 123.

It is also noted that the product return 160 may not necessarily be sent directly to the vendor 123, but may instead be sent to an agent of the vendor 123, to a facility of an agent of the vendor 123, or to another authorized third party. It is also noted that the shipped order 110a may not necessarily be shipped by the vendor 123 directly to the customer 105, and that the shipped order 110a may be sent to the customer 105 via an authorized third party.

An embodiment of the invention provides a functionality to associate (or attach) text information to a shipped order 110a in order to block the shipped order 110a. The return blocking system 150 provides a functionality to systemically prevent a product (or products) from a shipped order 110a from being returned to the vendor 123 (or to an authorized third party) by a customer 105, after the shipped order 110a to the customer 105 is blocked.

Any authorized agent 140 or supervisor 145 can enter the text information into the system 150, in order to indicate that a shipped order 110a is to be blocked. By blocking a shipped order 110a, a product return 160 related to the shipped order 110a will be blocked (i.e., a product return 160 related to the blocked shipped order 110a will be denied or will not be permitted/accepted by any call center agent 140 or by any supervisor 145).

In another embodiment as described below, when a shipped order 110 is blocked, an agent 140 (or supervisor 145) can specifically indicate the particular product(s) (in the shipped order 110) that is not permitted for return by the customer 105. Thus, in one embodiment, a product return 160 by a customer 105 can be prevented by the system 150 on a product-by-product basis (or item-by-item basis). Therefore, in a blocked shipped order 110a, the customer 105 may be able return a product in that blocked shipped order 110a and can not return at least one product in that blocked shipped order 110a, as described below.

All other agents 140 and all supervisors 145 can see the text information that indicates that a shipped order 110a has been blocked. As a result, all agents and all supervisors will have notice that a product return 160 related to a particular blocked shipped order 110a is to not be permitted.

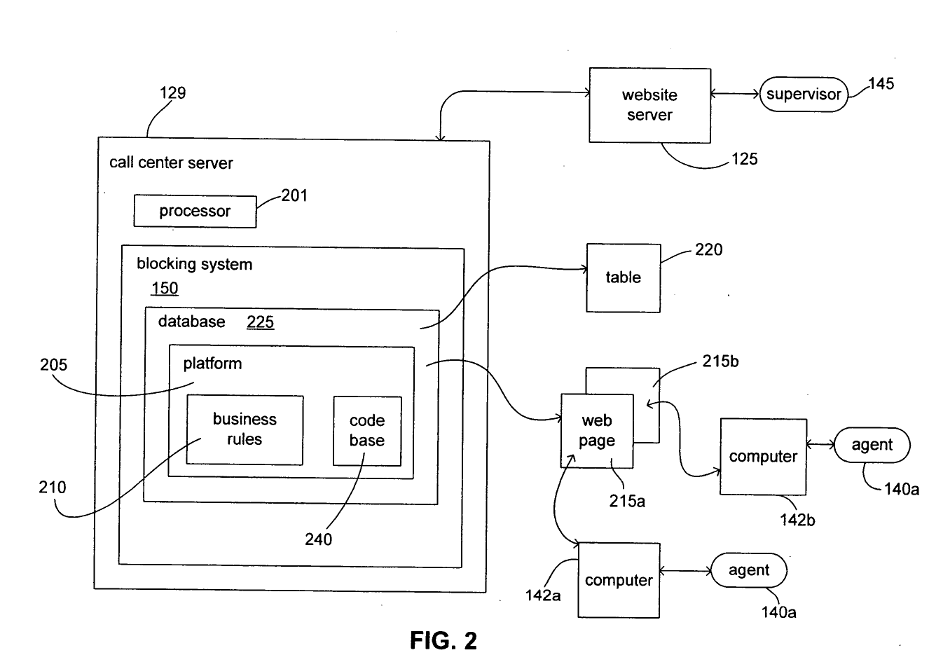

The product return 160 is typically sent by the customer 105 to the vendor 123. Once an agent 140 or a supervisor 145 sees that a shipped order 110a has been blocked, then the agent 140 will have notice to not accept a product return 160 from the customer 105 from that particular blocked shipped order 110a, and all agents 140 (and supervisors 145) will also be prevented from systemically accepting a product return 160 from that particular blocked shipped order 110a. The business rules 210 (see FIG. 2) may include programmed code to prevent an agent 140 or/and supervisor 145 from permitting his/her computer 142 (see computers 142a and 142b) to accept, approve, and process a product return 160 associated with a particular blocked shipped order 110a. As a result, the customer 105 will not be able to obtain refunds from the vendor 123 for a returned product and will also not be able to obtain another product(s) in exchange for a returned product.

FIG. 2 is a block diagram illustrating additional details of the product return blocking system 150 for blocking a shipped order 110a in order to prevent a product return 160 from the customer 105 to the vendor 123, in accordance with an embodiment of the invention. As mentioned above, the return blocking system 150 may be deployed in a server 129, which is typically a call center server. Typically, the server 129 may also deploy the applications that are used in a call center 121. A processor 201 in the server 129 can execute various software or applications in the product return blocking system 150 to permit various functionalities in accordance with embodiments of the invention.

In an embodiment, the return blocking system 150 includes (or can function with) an online commerce application platform 205 for providing, integrating, and maintaining electronic commerce (e-commerce) applications. One example of a suitable platform 205 is of a type available from BROADVISION, INCORPORATED, Redwood City, Calif. The platform 205 provides the data schema to permit the vendor 123 to offer personalized and secured electronic shopping for customers 105, and may also furnish comparative product information, price lists, and/or configuration assistance.

The platform 205 is typically stored in a database 225. One example of a suitable database 225 is of a type available form ORACLE CORPORATION, Redwood Shores, Calif., although other suitable types of databases may also be used.

The platform 205 operates based upon a set of business rules 210 that define the individuals who are permitted to block and unblock a shipped order 110a, in order to prevent or permit a product return 160 from a customer. For example, the business rules 210 can permit any agent 140 or/and any supervisor 145 to authorize the blocking or unblocking of a shipped order 110a.

The product return blocking system 150 advantageously prevents undesirable product returns 160 from customers 105 to the vendor 123. Examples of undesirable product returns include, but are not limited to, for example, unauthorized product returns, past 30-days product returns (or product returns that occur after expiration of a period in which product returns are permitted for customers), fraudulent product returns by customers 105, and/or other types of undesirable product returns.

Once information (indicating that a shipped order 110a is to be blocked) is entered, then the system 150 blocks any product return 160 related to that particular blocked shipped order 110a. An agent 140 or supervisor 145 will not be able to engage in any product return transactions for a particular blocked shipped order 110a. As an example, if a shipped order 110a is blocked, then the system 150 will prevent any agent 140 in the call center 129 (or any supervisor 145) to approve a product return 160 from that blocked shipped order 110a. As a result, the customer will not be able to obtain any refunds from a product in the blocked shipped order 110a and will not be able to exchange a product in the blocked shipped order 110a for another product.

In an embodiment, the system 150 will show a notice in the computer 142 of an agent 140 (or/and in a computer of a supervisor 145), with the notice indicating that a particular shipped order 110a has been blocked. As a result, the agent 140 or supervisor 145 will not approve any product return 160 from that particular shipped order 110a.

Embodiments of the system 150 permit the blocking and un-blocking of a return of shipped orders 110a at the user interface level, and this method of blocking and un-blocking is less complex and less time consuming for an authorized user. For example, a shipped order 110a can be blocked or unblocked by an agent 140a by entering information in a webpage 215a via a computer 142a. The agent 140a (or a supervisor 145) can enter text comments in a webpage 215a that a particular shipped order 110a has been blocked and enter the reasons for blocking the particular shipped order 110a. Other agents 140b (or other supervisors 145) can then view the particular shipped orders 110a that have been blocked and view the reasons for blocking the particular shipped orders 110a by viewing another webpage 215b via computer 142b. The other agents 140b (or supervisors 145) can, therefore, check the webpages 215 to determine if a product return 160 from a customer 105 will be accepted or rejected for the vendor 123.

Standard programming techniques can be used to create and format the webpages 215. A code base 240 provides the format and presentation for the webpages 215, permits processing the information that is input into a webpage 215 by a user, and permits other required functions for transactions involving the call center server 129. Additional details of an example webpage 215 are discussed below.

Once the information is entered in the webpage 215a to indicate that a particular shipped order 110a is to be blocked (or unblocked), then corresponding data is entered in a table 220 to permit the blocking (or un-blocking) of the shipped order 110a. This corresponding data permits the text notices to appear in the other webpages 215b that a particular shipped order(s) 110a has been blocked. Additional details of an example table 220 are discussed below.

In an embodiment, only authorized agents 140 (and/or only authorized supervisors 145) can block the return of a product, as where the authorized agents or supervisors are defined by the business rules 210. For example, the business rules 210 might require a password from an authorized agent 140 or authorized supervisor 145 before she/he can enter information in the webpage 215a to indicate that a particular shipped order 110a is to be blocked.

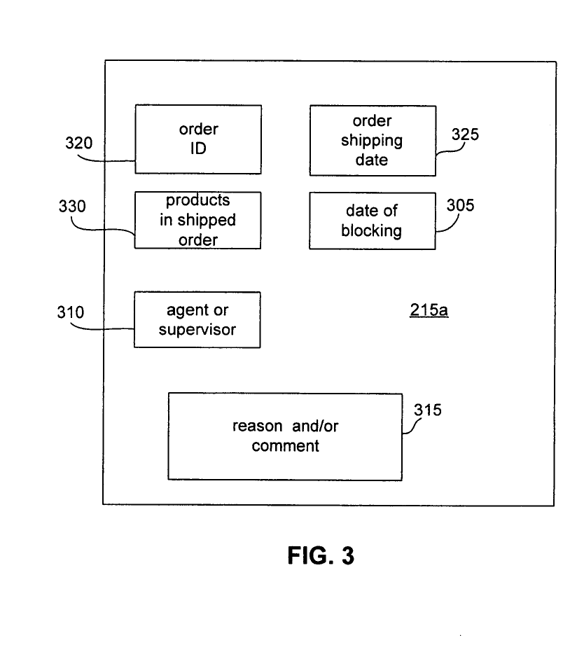

FIG. 3 is block diagram of a webpage 215a used in accordance with an embodiment of the invention. When an agent 140 (or a supervisor 145) blocks a shipped order 110a, the following information is provided in the call center application 135 by the agent 140 (or supervisor 145) who will block an order return 160:

(1) date on which the shipped order 110a was blocked (indicated in field 305 of webpage 215a); therefore, if a shipped order 110a has been blocked, a date or other indicator is placed in field 305 to give notice to an agent 140 or supervisor 145 that the shipped order 110a is blocked; otherwise, if a shipped order 110a is not blocked, then field 305 will be blank and will not contain a date.

(2) user (agent 140 or supervisor 145) who blocked the shipped order 110a (indicated in field 310 of webpage 215a); as an example, the agent 140a is blocking the shipped order 110a; the term “user” is defined as an agent 140 or supervisor 145.

(3) reason and/or comments for blocking the shipped order 110a (indicated in field 315 of webpage 215a) in order to block the product return 160.

In an embodiment, the webpage 215a also indicates, in field 320, an identifier (ID) of an order. The identifier may be, for example, a reference number to identify each order from a customer 105. The webpage 215a may also indicate, in field 325, the date on which the order was shipped to the customer. The webpage 215a may also indicate, in field 330, the particular product(s) in the shipped order 110a. Thus, the webpage 215a provides information about a shipped order 110a that the user can analyze, in order to determine if the shipped order 110a is to be blocked to prevent a return of a product(s) from the shipped order 110a.

As an example, the webpage 215a can be accessed by agent 140a via computer 142a, and at least some of the fields in the webpage 215a are filled by the agent 140a or supervisor 145 (also referred herein as “user”). To obtain information on a particular order 110 or to enter information about the particular order 110, the user enters the order ID in field 320. The user can block a shipped order 110a by entering a date of blocking the shipped order 110a in field 305, and can enter, in field 315, reasons or comments for blocking the shipped order 110a. As an example, if the current date is more than 30 days since the shipped order 110a was shipped to the customer 105, then the current date is past the product return time deadline.

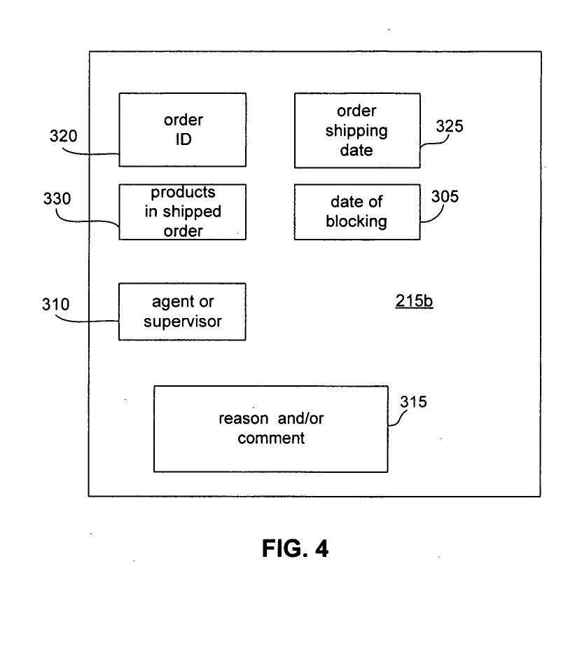

The information in the fields in webpage can then be seen in a similar webpage 215b (FIG. 4) by another user (e.g., another agent 140b or another supervisor 145) via computer 142b. As a result, the other user will be notified by the webpage 215b if particular shipped order 110a has been blocked (by viewing any date in the field 305) and the reason for blocking the shipped order 110a (by viewing the comment field 315). If a shipped order 110a has been blocked, then the user can deny a product return 160 from that blocked shipped order 110a. Since all agents 140 and supervisors 145 will see the text information in the webpages 215 that a product return 160 is to be denied for a particular blocked order 110a, all agents 140 and supervisors 145 can deny the return of the purchased product(s) from the blocked shipped order 110a. As a result, the customer 105 will not be given a refund or a product exchange for the denied product return 160.

Therefore, the text information that are input into the webpages 215 can permit all agents 140 and supervisors 145 to prevent at least one of the following types of undesirable product returns by a customer: (1) unauthorized product returns; (2) past 30-days product returns or product returns that occur after expiration of a period in which product returns are permitted for customers; (3) fraudulent product returns; and/or (4) other undesirable product returns.

An embodiment of the invention permits blocking of a shipped order 110a that is passed the normal time frame as set in a return policy of the vendor 123. For example, the normal time frame may be a 30 days return policy. Thus, an embodiment of the invention provides a solution to the problem of frequent customers who attempt to abuse the return policy. The user can check the field 325 to determine when the product was shipped to the customer 105, in order to detect any product returns 160 that are passed the time frame of the return policy. This solution also helps to reduce the return rate for shipped orders.

An embodiment of the invention also grants the ability for an agent 140 or supervisor 145 to unblock a shipped order 110a, in order to systematically set up or to permit a product return 160 from the unblocked shipped order 110a. A blocked shipped order 110a can be unblocked by deleting an entered blocking date (or other information) in field 305 of a webpage 215a. Additionally, the user can indicate, in field 315, that the particular blocked shipped order 110a has now been unblocked. A blocked shipped order 110a may be unblocked if, for example, the shipped order 110a was previously blocked by accident or if unblocking of the shipped order 110a is required to solve a customer satisfaction issue. Other reasons may be used to permit the unblocking of a blocked shipped order 110a.

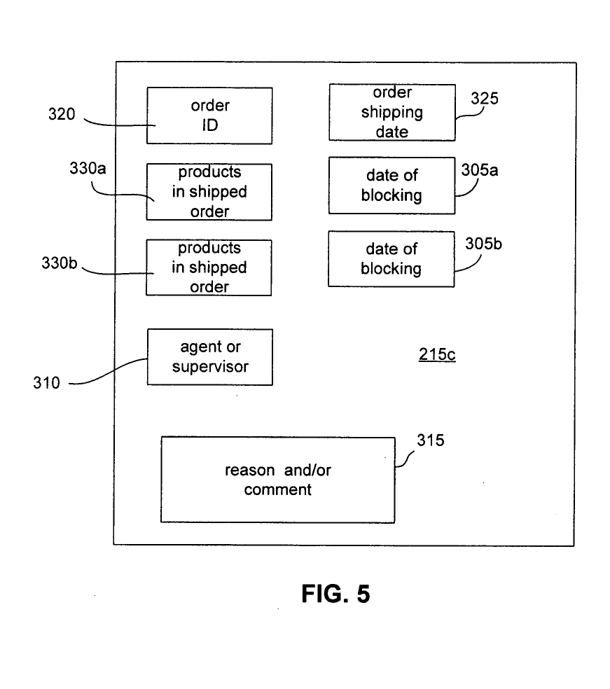

FIG. 5 is block diagram of a webpage 215c used in accordance with another embodiment of the invention. In this embodiment, when a shipped order 110a is blocked, then particular products in the shipped order 110a are prevented from being returned (on a product-by-product basis) by the customer 105 to the vendor 123. For example, assume that the vendor 123 has a 30-days product return policy. If a customer 105 purchased two products (e.g., one printer and one personal computer) in a shipped order 110a (e.g., on Aug. 1, 2003), and before 30-days (e.g., on Aug. 29, 2003), the customer 105 returned the printer in exchange for a second printer, but did not return/exchange the personal computer. The business rules 210 (FIG. 2) permit the blocking of the return of the personal computer after 30 days after the date of the order. However, the second printer will not be subjected to the 30-days return deadline after the date of the order; instead, the return of the second printer will be blocked at 30 days after the date of the exchanged (i.e., the return of the second printer will be blocked after Sep. 29, 2003 in this example). In this example, the product identifier for the printer is entered in field 330a and the product identifier for the personal computer is entered in field 330b. Initially, the blocking date of Aug. 30, 2003 is entered in fields 305a and 305b, which are the blocking dates for the printer and personal computer, respectively. If the original printer was exchanged for a second printer on Aug. 29, 2003 (which is assumed in this example as also the shipping date for this second printer), then the product identifier for the second printer can be entered into field 330b and the blocking date in field 305 can be changed to Sep. 29, 2003. It is understood that other product identifier fields 330 and other blocking date fields 305 may be added in the webpage 215c of FIG. 5.

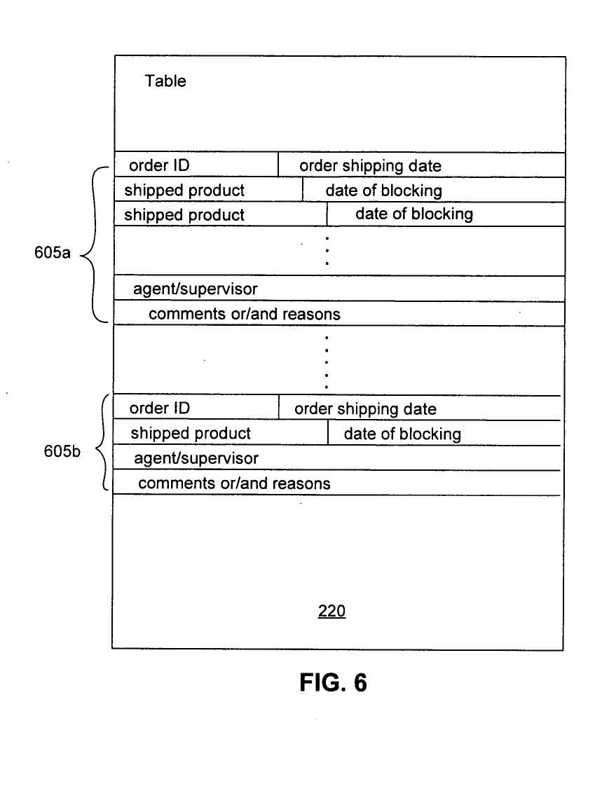

FIG. 6 is block diagram of a table 220 used in accordance with an embodiment of the invention. Standard table creation techniques can be used to create the table 220. The table 220 is stored in the database 225 and functions with the platform 205. The table 220 also functions with tables in the online shopping application 205.

In an embodiment, the table 220 stores one or more information 605 which relate to data entered by users in the webpages 215. In this example, information 605a and information 605b are stored in the table 220. Each information 605 includes an order ID, the shipping date of the order, an ID of each shipped product, the date of blocking of each shipped product, the ID of the user (agent or supervisor) who processed or blocked the shipped order, and/or comments and/or reasons that may have been entered by the user.

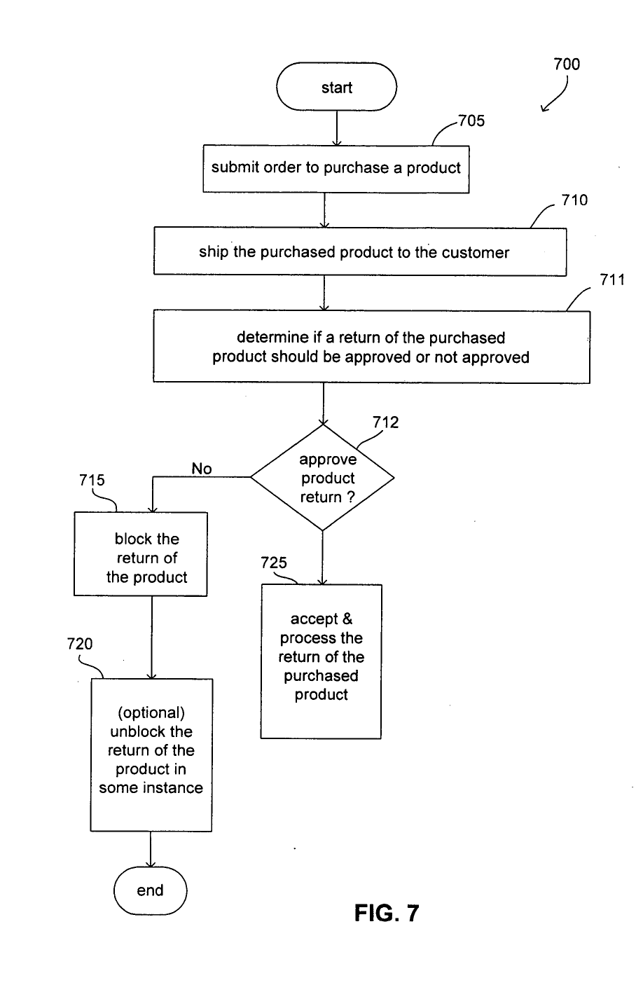

FIG. 7 is a flowchart of a method 700 for blocking returns, in accordance with an embodiment of the invention. A customer first submits (705) an order to a vendor in order to purchase one or more product(s), or to purchase a service(s) in some instance. The vendor (or an authorized agent of the vendor) then ships (710) the purchased product to the customer, if the customer's order is approved by the vendor. Thus, the order has been shipped to the customer.

If the customer attempts to return the purchased product(s) (or requests to return the purchased product(s)), then an agent 140 or supervisor 145 determined (711) if the return of the purchased product should be approved or not be approved. The agent 140 or supervisor 145 can determine approval or non-approval of the product return by analyzing the shipped order 110a (associated with the purchased product) in the webpage 215. In step (712), the agent 140 or supervisor 145 approves or disapproves the return of the purchased product.

If the return of the purchased product has been disapproved, then the return of the purchased product is blocked (715) and the return of the purchased product will not be permitted and will not be processed.

As an optional step, the agent 140 or supervisor 145 can unblock (720) the return of the purchased product(s) in some instance. As a result of unblocking (720) the return of the purchased product, the customer is permitted to return the purchased product(s) to the vendor.

On the other hand, if the return of the purchased product(s) is approved in step (712), the return of the purchased product is accepted and processed (725).

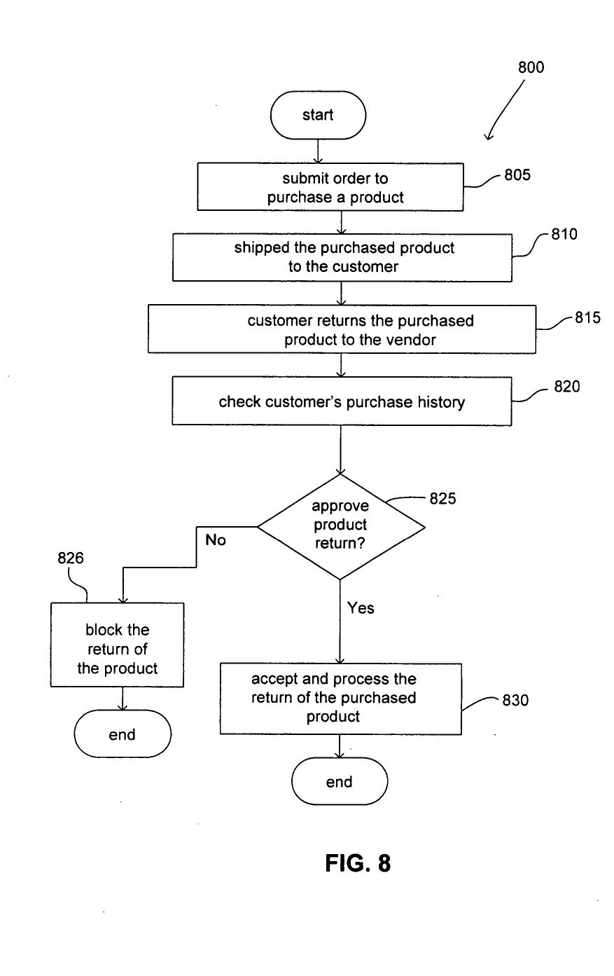

FIG. 8 is a flowchart of a method 800 for solving the problem of customers with frequent return behavior problem, in accordance with an embodiment of the invention. For example, a vendor 123 may have many customers 105 who abuse the 30-days normal return policy by purchasing a product, using the purchased product for less than 30-days (e.g., 25 days), and then returning the purchased product to the vendor 123, and exchanging the returned product for a new (or another) product. Often times, agents can see the customer's purchase history, as it will show a purchase, then a return, another purchase, another return, etc. As an example, if an agent sees a customer purchasing 3 or 4 notebook computers within a 3-month period of time, then the agent can detect/conclude that this is not a normal purchasing behavior for a consumer.

In an embodiment of the method 800, the customer first submits (805) an order to a vendor in order to purchase one or more product(s), or to purchase a service(s) in some instance. The vendor (or an authorized agent of the vendor) then ships (810) the purchased product to the customer, if the customer's order is approved by the vendor. Thus, the order has been shipped to the customer.

A customer may then seek to return (815) one or more of the purchased product (from the shipped order) to the vendor. The user (e.g., an agent 140 or supervisor 145 in FIG. 2) then checks (820) the customer's purchase history in order to determine if the return of the purchased product will be approved. As an example, the user can check the comments field 315 in webpage 215 to determine if the customer is returning this same type of product in multiple instances (e.g., three returns) within a short time period (e.g., 3 months). Alternatively, the webpage 215 may have a separate field that indicate each product that has been returned by the customer and the date of the product return(s), for each shipped order 110a. Other types of indicators may be configured in a webpage 215 to track the product return behavior of a customer.

After the user has checked the customer's purchase history, the user can approve or not approve the product return by the customer, in step (825). If the user does not approve the product return by the customer, then return of the purchased product is blocked (826) and the return of the purchased product will not be permitted and will not be processed On the other hand, if the user approves the product return by the customer, then the user can accept and process (830) the return of the purchased product. For example, the user may permit the customer to obtain a refund for the returned product or to exchange the returned product for another product.

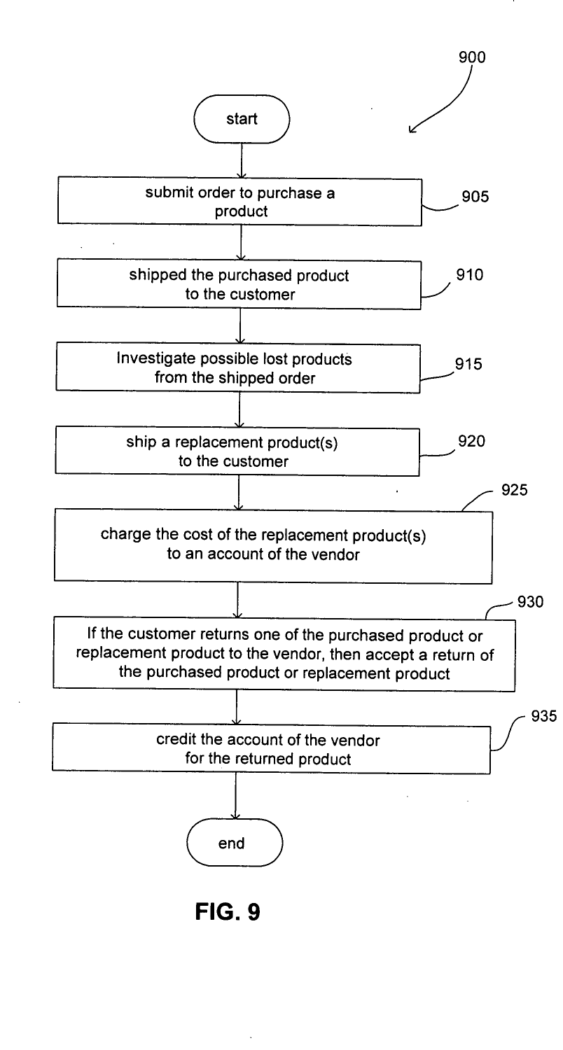

FIG. 9 is a flowchart of a method 900 for solving the problem of lost orders, in accordance with an embodiment of the invention. If a product from a shipped order 110a is lost while in transit to a customer's 105 delivery location, then a delivery team member of the vendor 123 can research/investigate the delivery of the product. If the delivery team member can not locate the delivered product, then the member will typically order the similar product and charge the cost to the company credit card of the vendor 123. After the above steps occur, there will be two open orders: (1) the customer's lost order, and (2) the subsequent open order (by the delivery team member) which is to be delivered to the customer's delivery location. The new process provided by an embodiment of the invention permits the blocking of the return of the customer's lost order. By chance that a customer receives 2 ordered products and wants to return the products from one of the shipped orders back to the vendor, then a credit will be made to the company credit card and not the customer's credit card. If a credit were made to the customer's credit card, then the customer would end up with two products and no net charges to the customer's credit card for the product sale.

In an embodiment, the method 900 begins with a customer first submitting (905) an order to a vendor in order to purchase one or more product(s), or to purchase a service(s) in some instance. The vendor (or an authorized agent of the vendor) then ships (910) the purchased product to the customer, if the customer's order is approved by the vendor. Thus, the order has been shipped to the customer.

Assume that the customer notifies the vendor that she/he has not received the purchased product(s) from the shipped order. A delivery team member (or other personnel) of the vendor can then research/investigate (915) the delivery of the product and determine if the purchased product from the shipped order has been lost. If the delivery team member can not locate the purchased product, then the member will typically order the similar replacement product for the customer and ship (920) the replacement product to the customer. The delivery team member charge (925) the cost of the replacement product to an account of the vendor (e.g., a company credit card of the vendor 123). After the above steps occur, there will be two open orders: (1) the customer's lost order, and (2) the subsequent open order (by the delivery team member) which is to be delivered to the customer's delivery location. By chance that a customer receives 2 ordered products (the original purchased product and the replacement product) and wants to return one of the products back to the vendor, then an agent 140 or supervisor 245 of the vendor can accept (930) one of the returned products. The agent 140 or supervisor 145 can view the webpage 215 to determine that two orders have been previously shipped to the customer and that the product return should be permitted. If the agent 140 or supervisor 145 accepts the returned product, then a credit will be made (935) to the account of the vendor (e.g., the company credit card) for the returned product, and credit is not made to the customer's credit card.

The various engines and modules discussed herein may be, for example, software, commands, data files, programs, code, firmware, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method of blocking a return of products from a customer, the method comprising:
submitting, by the customer, an order to purchase a product from a vendor;
shipping the purchased product to the customer;
determining if a return of the purchased product should be approved or not be approved; and
if the return of the purchased product is not approved, then blocking the return of the purchased product in order to prevent the return of the purchased product.

2. The method of claim 1, further comprising:
if the return of the purchased product is approved, then accepting and processing the return of the purchased product.

3. The method of claim 1, further comprising:
if the return of the purchased product has been blocked, then unblocking the return of the purchased product in some instances to permit the return of the purchased product.

4. The method of claim 1, wherein the determination if return of the purchased product should be approved or not be approved includes a review of the order by a personnel of the vendor.

5. The method of claim 1, wherein the order is submitted by the customer to a call center.

6. The method of claim 1, wherein the order is submitted by a customer to an online shopping website.

7. The method of claim 1, wherein blocking the return of the purchased product comprises:
entering text information associated with the purchased product to indicate that the return of the purchased product is to be denied.

8. The method of claim 7, wherein the text information is entered into a webpage.

9. The method of claim 1, wherein blocking the return of the purchased product comprises:
entering a text comment that indicates a reason why the return of the purchased product is blocked.

10. The method of claim 9, wherein the text comment is entered into a webpage.

11. The method of claim 1 wherein blocking the return of the purchased product prevents a refund to the customer for the purchased product.

12. The method of claim 1 wherein blocking the return of the purchased product prevents an exchange of the purchased product with another product.

13. An article of manufacture, comprising:
a machine-readable medium having stored thereon instructions to:
receive an order to purchase a product by a customer;
determine if a return of the purchased product should be approved or not be approved; and
block the return of the purchased product in order to prevent the return of the purchased product if the return of the purchased product is not approved.

14. An apparatus for blocking a return of products from a customer, the apparatus comprising:
means for receiving an order to purchase a product by a customer;
means for determining if a return of the purchased product should be approved or not be approved; and
means for blocking the return of the purchased product in order to prevent the return of the purchased product if the return of the purchased product is not approved.

15. An apparatus for blocking a return of products from a customer, the apparatus comprising:
a product return blocking system configured to receive an order to purchase a product by a customer, determine if a return of the purchased product should be approved or not be approved, and block the return of the purchased product in order to prevent the return of the purchased product if the return of the purchased product is not approved.

16. The apparatus of claim 15, wherein the product return blocking system is further configured to accept and process the return of the purchased product, if the return of the purchased product is approved.

17. The apparatus of claim 15, wherein the product return blocking system is further configured to unblock the return of the purchased product in some instances to permit the return of the purchased product, if the return of the purchased product has been blocked.

18. The apparatus of claim 15, wherein the determination if return of the purchased product should be approved or not be approved includes a review of the order by a personnel of the vendor.

19. The apparatus of claim 15, wherein the order is submitted by the customer to a call center.

20. The apparatus of claim 15, wherein the order is submitted by a customer to an online shopping website.

21. The apparatus of claim 15, wherein the product return blocking system blocks the return of the purchased product by receiving entered text information associated with the purchased product to indicate that the return of the purchased product is to be denied.

22. The apparatus of claim 21, wherein the text information is entered into a webpage provided by the product return blocking system.

23. The apparatus of claim 15, wherein product return blocking system blocks the return of the purchased product by receiving an entered text comment that indicates a reason why the return of the purchased product is blocked.

24. The apparatus of claim 23, wherein the text comment is entered into a webpage provided by the product return blocking system.

25. The apparatus of claim 15 wherein blocking the return of the purchased product prevents a refund to the customer for the purchased product.

26. The apparatus of claim 15 wherein blocking the return of the purchased product prevents an exchange of the purchased product with another product.

27. A method of blocking a return of products from a customer, the method comprising:
submitting, by the customer, an order to purchase a product from a vendor;
shipping the purchased product to the customer;
checking a purchase history of the customer to determine if a return of the purchased product should be approved or not be approved; and
if the return of the purchased product is not approved, then blocking the return of the purchased product in order to prevent the return of the purchased product.

28. The method of claim 27, further comprising:
if the return of the purchased product is approved, then accepting and processing the return of the purchased product.

29. A method of solving a lost order problem, the method comprising:
submitting, by the customer, an order to purchase a product from a vendor;
shipping the purchased product to the customer;
investigating a possible lost of the purchased product;
shipping a replacement product to the customer;
charging a cost of the replacement product to an account of the vendor;
if the customer returns one of the purchased product or the replacement product, then accepting a return of the purchased product or the replacement product; and
crediting the account of the vendor for the returned product.

30. The method of claim 29, wherein the account of the vendor comprises a company credit card of the vendor.
